(19) United States
(12) Patent Application Publication
(10) Pub. No.: US 2010/0275041 A1
(43) Pub. Date: Oct. 28, 2010

(54) COMPUTER POWER SUPPLY AND POWER STATUS SIGNAL GENERATING CIRCUIT THEREOF

(75) Inventors: HAI-QING ZHOU, Shenzhen City (CN); CHUNG-CHI HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/468,018

(22) Filed: May 18, 2009

(30) Foreign Application Priority Data
Apr. 25, 2009 (CN) 200910301853.8

(51) Int. Cl. G06F 1/00

(52) U.S. Cl. 713/300

(57) ABSTRACT

A computer power supply includes a system voltage output terminal, a standby voltage output terminal, and a power status signal generating circuit comprising an amplifier and an electrical switch. A terminal of a first resistor is connected to the system voltage output terminal. The other terminal of the first resistor is grounded via a capacitor and connected to a non-inventing terminal of the amplifier. A terminal of a second resistor is connected to the standby voltage output terminal. The other terminal of the second resistor is grounded via the third resistor and connected to an inverting terminal of the amplifier. An output terminal of the amplifier outputs a power status signal. A terminal of a fourth resistor is connected to the system voltage output terminal. The other terminal of the fourth resistor is connected to the output terminal of the amplifier and receives a start signal via the electrical switch.

### BACKGROUND

1. Technical Field

The present disclosure relates to computer power supplies and, particularly, to a computer power supply with a power status signal generating circuit.

2. Description of Related Art

A computer power supply provides voltages to a computer mainboard, and it also provides a power status signal, sometimes called a PWR_GOOD signal, to the computer mainboard. The PWR_GOOD signal is to indicate to the computer mainboard that the computer power supply is working normally and that the computer mainboard can continue to operate. If the PWR_GOOD signal is not present, the computer mainboard will shut down. The PWR_GOOD signal prevents the computer mainboard from attempting to operate on improper voltages and damaging itself. The computer mainboard provides a start signal, sometimes called a PS_ON signal, to the computer power supply to turn on the computer power supply.

The PWR_GOOD signal is a 5 volt signal generated in a computer power supply when the computer power supply has passed internal self-tests and the computer power supply's outputs have stabilized. The PWR_GOOD signal is normally generated after a delay of about 0.1 to 0.5 seconds after the computer power supply is switched on. However, some power supplies may not provide a standard PWR_GOOD signal to computer mainboards. Voltage levels and delay times of the PWR_GOOD signal may not be standard, which may cause malfunction of the computer. Additionally, some PWR_GOOD signals of some computer power supplies have signal shake when the computer power supplies are shut down, which may disturb time sequences of the computer mainboards.

### BRIEF DESCRIPTION OF THE DRAWINGS

FIG. 1 is a circuit diagram of an exemplary embodiment of a computer power supply, together with a computer mainboard.

FIG. 2 is a waveform chart of a power status signal and a start signal of the computer power supply of FIG. 1.

### DETAILED DESCRIPTION

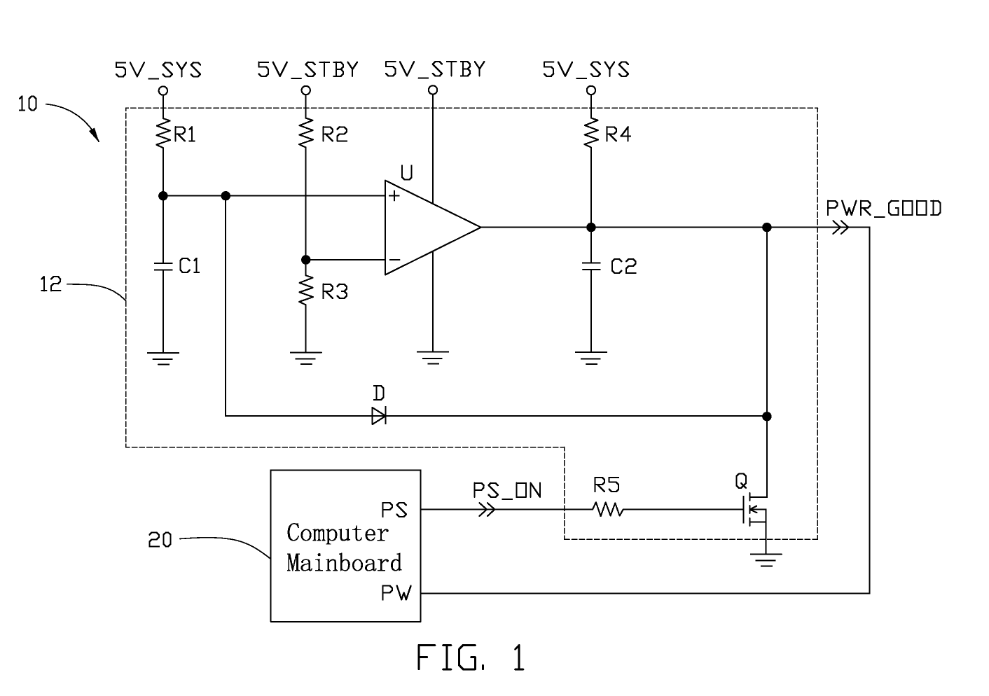

Referring to FIG. 1, an exemplary embodiment of a computer power supply 10 used to supply power to a computer mainboard 20 is presented. The computer power supply 10 includes a system voltage output terminal 5V SYS, a standby voltage output terminal 5V_STBY, and a power status signal generating circuit 12. The system voltage output terminal 5V_SYS is to output a 5V system voltage from a system voltage generating circuit (not shown) to the power status signal generating circuit 12. The standby voltage output terminal 5V_STBY is to output a 5V standby voltage from a standby voltage generating circuit (not shown) to the power status signal generating circuit 12. The power status signal generating circuit 12 is to output a power status signal PWR_GOOD to a power status receiving pin PW of the computer mainboard 20, after a start signal output pin PS of the computer mainboard 20 outputs a start signal PS_ON to the computer power supply 10. The system voltage generating circuit and the standby voltage generating circuit are known circuits, and so are not described here.

The power status signal generating circuit 12 includes an operational amplifier U, five resistors R1-R5, two capacitors C1 and C2, a diode D, and a field-effect transistor (FET) Q as an electrical switch.

A first terminal of the resistor R1 is connected to the system voltage output terminal 5V_SYS. A second terminal of the resistor R1 is grounded via the capacitor C1. A node between the resistor R1 and the capacitor C1 is connected to a non-inverting terminal of the amplifier U and an anode of the diode D. A first terminal of the resistor R2 is connected to the standby voltage output terminal 5V_STBY. A second terminal of the resistor R2 is grounded via the resistor R3. A node between the resistor R2 and the resistor R3 is connected to an inverting terminal of the amplifier U. A positive voltage terminal of the amplifier U is connected to the standby voltage output terminal 5V_STBY. A negative voltage terminal of the amplifier U is grounded. An output terminal of the amplifier U is to output the power status signal PWR_GOOD. A first terminal of the resistor R4 is connected to the system voltage output terminal 5V_SYS. A second terminal of the resistor R4 is grounded via the capacitor C2. A node between the resistor R4 and the capacitor C2 is connected to the output terminal of the amplifier U. A cathode of the diode D is connected to the output terminal of the amplifier U and a drain, as a first terminal, of the FET Q. A source, as a second terminal, of the FET Q is grounded. A gate, as a third terminal, of the FET Q is connected to the start signal output pin PS of the computer mainboard 20 via the resistor R5, to receive the start signal PS_ON.

In one embodiment, the resistor R1 and the capacitor C1 form a delay circuit, which can control a delay time of the PWR_GOOD signal, and the delay time may be controlled to be between 0.1 and 0.5 seconds. The diode D is used to discharge the capacitor C1 quickly. The capacitor C2 is a high frequency filter capacitor for filtering noise when the PWR_GOOD signal is reversed. In other embodiments, the 5V system voltage 5V SYS and the 5V standby voltage 5V_STBY can be adjusted according to requirements. The FET Q can be replaced with some other kind of electrical switch, such as a relay.

In use, when the computer power supply 10 is connected to an external power source, such as a 110V alternating current (AC) power source, the computer power supply 10 outputs the 5V standby voltage to the computer mainboard 20. At this time, some circuits of the computer mainboard 20 work and await a start operation of the computer mainboard 20, this status can be called a holding status. When the computer mainboard 20 is switched on, the start signal PS_ON is changed to a low voltage level from a high voltage level, thereby the computer power supply 10 is switched on to output all voltages to the computer mainboard 20. Because the start signal PS_ON is a low voltage signal, the FET is turned off, the capacitor C1 is charged by the 5V system voltage 5V_SYS via the resistor R1. When a voltage of the non-inverting terminal of the amplifier U is greater than a voltage of the inverting terminal of the amplifier U, the amplifier U outputs a high voltage level power status signal PWR_GOOD to the computer mainboard 20. The computer mainboard 20 is booted up after receiving the power status signal PWR_GOOD.

When the computer mainboard 20 is turned off, the start signal PS_ON is changed to a high voltage level from a low voltage level, the computer power supply 10 closes all voltages except the 5V standby voltage 5V_STBY. At this time, the FET Q is turned on rapidly, thereby the power status signal PWR_GOOD is changed to a low voltage level rapidly, so that it will not disturb a time sequence of the computer mainboard 20. In addition, the capacitor C1 is discharged via the diode D quickly, so that it is prepared for the next starting of the computer mainboard 20. In other embodiments, the diode D and the capacitor C2 can be omitted to save on costs.

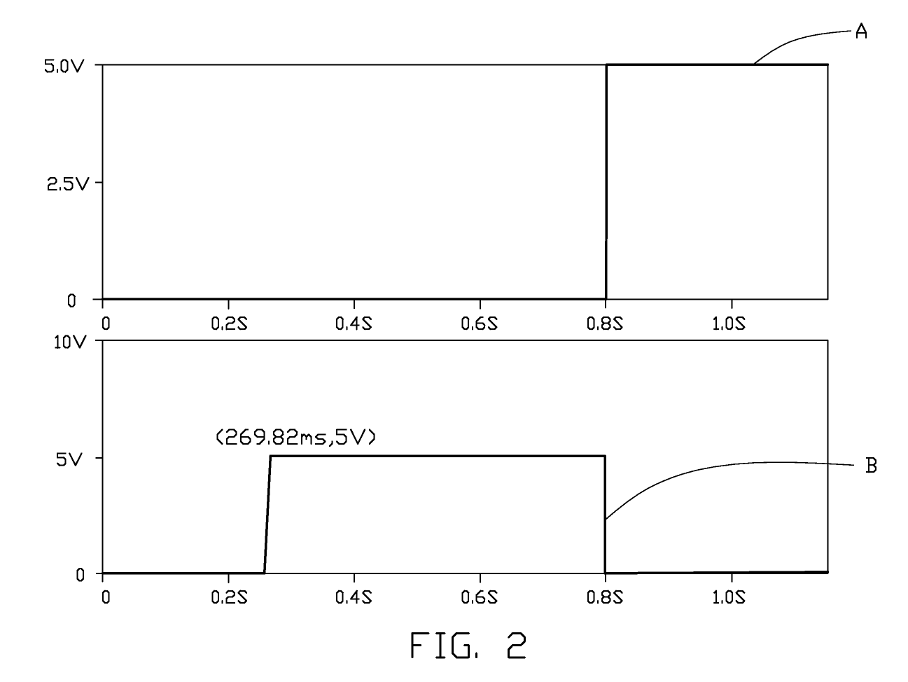

Referring to FIG. 2, “A” is a waveform of the start signal PS_ON, and “B” is a waveform of the power status signal PWR_GOOD. In one embodiment, the delay time of the power status signal PWR_GOOD is 369.85 ms, which satisfies the standard range between 0.1 and 0.5 seconds. The voltage level of the power status signal PWR_GOOD is 5V, which satisfies voltage requirement. In addition, the power status signal PWR_GOOD is rapidly charged to a low voltage level at 0.8 s, and has no signal shake.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A computer power supply, comprising:
a system voltage output terminal to output a system voltage;
a standby voltage output terminal to output a standby voltage; and
a power status signal generating circuit, comprising:
an operational amplifier;
a first to a fifth resistors;
a capacitor; and
an electrical switch;
wherein a first terminal of the first resistor is connected to the system voltage output terminal, a second terminal of the first resistor is grounded via the capacitor, a node between the first resistor and the capacitor is connected to a non-inventing terminal of the amplifier, a first terminal of the second resistor is connected to the standby voltage output terminal, a second terminal of the second resistor is grounded via the third resistor, a node between the second and third resistors is connected to an inverting terminal of the amplifier, an output terminal of the amplifier is to output a power status signal, a first terminal of the fourth resistor is connected to the system voltage output terminal, a second terminal of the fourth resistor is connected to the output terminal of the amplifier and a first terminal of the electrical switch, a second terminal of the electrical switch is grounded, a third terminal of the electrical switch is to receive a start signal from a computer mainboard via the fifth resistor, wherein the electrical switch is turned off in response to the start signal being a low level voltage, and turned on in response to the start signal being a high level voltage.

2. The computer power supply of claim 1, wherein the power status signal generating circuit further includes a diode, an anode of the diode is connected to the node between the first resistor and the capacitor, a cathode of the diode is connected to the first terminal of the electrical switch.

3. The computer power supply of claim 1, wherein the power status signal generating circuit further includes a high frequency filter capacitor connected between the output terminal of the amplifier and ground.

4. The computer power supply of claim 1, wherein the electrical switch is a field-effect transistor (FET), the first to third terminals of the electrical switch are corresponding to a drain, a source, and a gate of the FET, respectively.

5. The computer power supply of claim 1, wherein the system voltage and the standby voltage are both 5 volt voltages.

6. A power status signal generating circuit to generate a power status signal for a computer power supply, the power status signal generating circuit comprising:
an operational amplifier;
a first to a fifth resistors;
a capacitor; and
an electrical switch;
wherein a first terminal of the first resistor is to receive a system voltage, a second terminal of the first resistor is grounded via the capacitor, a node between the first resistor and the capacitor is connected to a non-inventing terminal of the amplifier, a first terminal of the second resistor is to receive a standby voltage, a second terminal of the second resistor is grounded via the third resistor, a node between the second and third resistors is connected to an inverting terminal of the amplifier, an output terminal of the amplifier is to output the power status signal, a first terminal of the fourth resistor is to receive the system voltage, a second terminal of the fourth resistor is connected to the output terminal of the amplifier and a first terminal of the electrical switch, a second terminal of the electrical switch is grounded, a third terminal of the electrical switch is to receive a start signal from a computer mainboard via the fifth resistor, wherein the electrical switch is turned off in response to the start signal being a low level voltage, the electrical switch is turned on in response to the start signal being a high level voltage.

7. The power status signal generating circuit of claim 6, further comprising a diode, wherein an anode of the diode is connected to the node between the first resistor and the capacitor, a cathode of the diode is connected to the first terminal of the electrical switch.

8. The power status signal generating circuit of claim 6, further comprising a high frequency filter capacitor connected between the output terminal of the amplifier and ground.

9. The power status signal generating circuit of claim 6, wherein the electrical switch is a field-effect transistor (FET), the first to third terminals of the electrical switch are corresponding to a drain, a source, and a gate of the FET, respectively.

10. The power status signal generating circuit of claim 6, wherein the system voltage and the standby voltage are both 5 volt voltages.
